(19) United States
(12) Patent Application Publication
(10) Pub. No.: US 2002/0064386 A1
(43) Pub. Date: May 30, 2002

(54) Moving and positioning apparatus and method

(75) Inventor: Scott Losmandy, Studio City, CA (US)

Correspondence Address: Riordan & McKinzie, 300 South Grand Avenue, 29th Floor, Los Angeles, CA, 90071, US

(73) Assignee: HOLLYWOOD GENERAL MACHINING, INC.

(21) Appl. No.: 09/727,968

(22) Filed: Nov. 30, 2000

(51) Int. Cl. G03B 17/00

(52) U.S. Cl. 396/419

(57) ABSTRACT

The present invention is an apparatus and method to move and position a device, such as a camera mounted on a dolly, in a smooth, flexible and precise manner. This is accomplished by positioning two flexible semi-rigid rails parallel to one another such that a dolly with wheels can be placed on and guided by the flexible semi-rigid rails. Because the flexible rails are uniform, smooth movement is ensured. Further, due to the lightweight nature of the flexible rails, transportation and portability problems are significantly minimized as compared with presently available metal tracks. The flexible semi-rigid rails can be air pressurized tube for heavier loads or be made of solid extruded materials for lighter loads. Finally, the flexible semi-rigid rails allow for a wide array of positioning without the cumbersome need to change or connect pieces of metal track, thereby achieving ultimate adaptability.

### BACKGROUND OF THE INVENTION

1. Field of Invention

The present invention relates to a camera dolly track apparatus and method used in the film and video industry to move and position cameras.

2. Description of Prior Art

In the film and video industry, camera movement is often necessary to accomplish a desired shot. To do this, a camera is generally mounted to a dolly with a set of wheels or rollers. The rollers are placed on a track and the camera-dolly unit is displaced by a push rod, usually connected to the dolly.

For many years, the film and video industry has used metal tracks to guide the movement of a camera while shooting. The importance of the tracks is that it enables the camera to move along a predetermined path to obtain the desired shot while shooting is in progress. Using track, rather than hand held techniques, generally results in a steadier, more predictable “take”.

Despite the benefits of the camera track presently available, there are serious shortcomings. Dolly track is made of nickel-plated steel tubing, usually one-and-a-half inches (1.5″) in diameter. Two parallel tubular pieces of tubing are held together by steel cross members permanently attached to the tubing. While track can be scissored to narrow the width for transporting purposes, the length of the track cannot be shortened. The ends of the tubing alternate as male tapered studs and female tapered receptacles thereby allowing separate tubular pieces to be interconnected. Cinching devices, located at the end of the track, are used to securely interconnect tubular pieces. Straight track, used for linear movement, is commonly available in lengths from two feet (2 ft.) to twenty feet (20 ft.).

Often in the film industry, it is frequently necessary to move the camera in a curved, non-linear manner. For this purpose, curved metal track is used in the industry. Curved track is constructed in the same manner as the straight track, except that the inner and outer tracks are shaped on different radii to create a curve for the dolly move. The radius of a curved dolly track is measured from the mid-point between the two rails of the track. And unlike straight track, the curved pieces do not scissor together for transport. The most common curved track is a forty-five degree (45°), ten-foot (10-ft.) radius track. Only four different radius sizes of curved track are presently available in the marketplace. Accordingly, curved camera movement is constrained to standard radius sizes, which means the decision on which type of curved track to bring to the set must be carefully preplanned, or the expense of bringing track in a variety of different radii must be endured.

The traditional construction of dolly track provides stability, but is not amenable to easy transportation. Although straight track is easier to transport than curved track, it too poses transportation difficulties because of its size and weight. For example, forty feet (40 ft.) of traditional track weighs a total of one hundred and seventy-six pounds (176 lbs.) and needs some twelve feet (12 ft.) of flatbed length for transportation. Curved dolly track is even more difficult to transport because in addition to size and weight, it is not collapsible and is therefore extremely clumsy and space consuming to transport.

Another common dolly track problem involves the camera “seeing” the track in a shot when, for example, the camera is pulled back. Because standard track is securely fastened, rigid and noisy to move, changes to the track configuration during a shot, for example, to try to remove the track as the camera dollies back, is so difficult that it is rarely attempted.

Another problem is that the steel cross members present a challenge and hazard to actors and crew members who work in and around the track who may trip and fall. Actors, who often need to walk between the dolly rails during a shot, must learn to walk in such a way as to give the impression that their upper bodies are moving naturally, as if they were walking normally without obstruction. In reality actors must time their movement and awkwardly step over the dolly track cross supports to avoid tripping with presently available track.

Yet another problem that exists in presently available dolly track involves the seams between pieces of track. Despite the fit of the male and female ends of the tubular pieces of the dolly track and the cinching device used to secure the connection, a small gap or imperfect alignment usually persists between pieces of track. Thus, when the camera and dolly are rolled, the seams are “felt” by the camera causing a break in the steadiness of the camera movement and the shot.

Attempts to remedy some of these shortcomings have not been successful. In an attempt to remedy the portability problems, dolly tracks have been made out of aluminum and PVC pipe material. While this has resulted in lighter dolly tracks, long sections of track must still be accommodated in travel. Further, the problems associated with dolly track seams is often aggravated by use of these lighter materials. In other words, the agitation felt by the camera and dolly when passed over a seam is even greater when using lighter materials. Finally, currently used curved track made of lighter material have many of the same setbacks as their steel counterparts, including a lacking in collapsibility and large range of curvature.

Previous attempts at remedying the problems associated with track seams have resulted in new problems. One dolly track system, known as Precision Track, reduces the seam connection problem, but is also far heavier than standard steel dolly track used in the industry today. This track solves one problem only to aggravate others, such as problems with transportability. Further, the lack of collapsibility and limited range of track curvature discussed above are also problems associated with Precision Track. Accordingly, no presently available track system alleviates all the problems discussed above.

In view of the foregoing, there is a need for a dolly track apparatus that overcomes the deficiencies in the prior art.

### SUMMARY OF THE INVENTION

The present invention is a moving and positioning apparatus which incorporates flexible semi-rigid rails, in the form of tubes or solid extruded rubber, to replace the steel, aluminum, or PVC materials currently in use as dolly tracks. Addressing needs in the film and video industry, the present invention provides the flexibility of movement attributed to hand-held camera methods with the steadiness, predictability and repeatability offered by conventional metal tracks. In one preferred embodiment of the present invention, the flexible semi-rigid rails have reinforced linings and are air pressurized for increased rigidity to handle heavier dolly loads. In another preferred embodiment, the rails are formed by solid extruded rubber which is ideal for lighter weight camera-dolly systems.

The present invention must be sufficiently rigid to support the weight of a dolly, camera and related apparatus, yet sufficiently flexible to allow quick and easy placement and adjustment. The present invention allows tracks to be positioned as desired, without being limited to curves of predetermined radii. Because the present invention can be manipulated as needed, it provides practically a limitless range of track curvature.

Another advantage of the present invention is that it lacks seams. The present invention is available in any solid length up to 250 feet (250 ft.) without a seam, ensuring smooth movement of the camera along the entire length of the track. Yet another advantage of the present invention is its light weight construction, which provides an ease of portability. Unlike metal dolly track, the present invention is significantly lighter and easier to transport. A forty foot (40-ft.) piece of track in the present invention weighs forty pounds (40 lbs.), and thus the two pieces of track needed to make a forty-foot (40-ft.) dolly run weighs eighty pounds (80 lbs.) which is half the weight of traditional track. More importantly, the present invention rolls up into an 18″×18″×14″ bundle, that can fit easily into the trunk of a small car. As previously discussed, forty feet (40 ft.) of steel track needs some twelve feet (12 ft.) of flatbed length for transportation.

The present invention is also adaptable to differing types of shots. For example, in a “pull back” shot, a problem encountered is track visibility. In other words, as the camera's view widens, the dolly track may enter the frame of the picture. With use of the present invention, this problem is easily overcome by simply pulling the flexible track away as the camera progresses backwards without the noise associated with metal track. Additionally, the camera can more easily and effectively be pulled forward in one direction, and pulled back in another direction, and vice versa with the present invention. For example, a camera can be moved in towards a subject in a straight line. The present invention can then be repositioned in a curved configuration, and the camera can be moved back away from the subject now following a path different from its original motion. With the present invention, these changes can be effectively accomplished during a single shot without interruption. Combinations of this type of adaptability are practically limitless, and can be done without the need to stop the camera. Furthermore, actors will appreciate the lack of cross supports in the present invention. Unlike presently available track having cross members, there is nothing to step over when one is required to walk between the tracks in the present invention.

In a preferred embodiment designed for heavier dollies, air-pressurized and steel reinforced rubber tubing is used. The air-pressurization is accomplished by mounting custom fittings at each end of the flexible semi-rigid tubes. At one end a standard automobile tire fitting acting as a plug is used, while at the other end a custom fitting having an inserted valve is used. Ridges on the standard and custom fittings secure the fitting to the interior of the flexible semi-rigid tubes. The ends are then banded to prevent the fittings from escaping due to over-pressurization or normal wear and tear. The tubing in a preferred embodiment, rated at 250 psi, needs no more than 60 psi to handle dolly loads of up to seven hundred pounds (700 lbs.), thereby ensuring the integrity of the air-pressurized system. Air is introduced to the flexible semi-rigid tubes by a standard bicycle hand or foot pump.

In another preferred embodiment designed for light weight dollies, the present invention used solid piece of extruded rubber for the rails. This provides the same working advantages as the air-pressurized tubing, but does away with the need of a pump. Furthermore, since the rail is solid material without air-pressure fittings, the ends can be drilled and coupled by means of an inserted dowel pin. Thus longer runs can be created from shorter sections, without seam compromise, to avoid carrying longer sections of track than are needed.

The present invention may be better understood by referring to the following detailed description, which should be read in conjunction with the accompanying drawings. The detailed description of a particular preferred embodiment, described below, is intended to be a particular example, and not a limitation.

### BRIEF DESCRIPTION OF THE DRAWINGS

The accompanying drawings, which are incorporated in and constitute a part of the specification, illustrate presently preferred embodiments of the invention, and together with the preceding general description and the following detailed description, explain the principles of the invention.

In the drawings:

FIG. 1 is a side view of the rail of a preferred embodiment of the present invention comprising air-pressurized, steel reinforced, flexible tubing having a valve located at one end of the flexible semi-rigid tubes and a plug at the other end.

FIG. 1a is a side view of a standard fitting used as the plug for one end of the tubing in a preferred embodiment of the present invention.

FIG. 1b is a cross-sectional side view of a custom fitting having an inserted valve.

FIG. 1e is a side view of a connectable fitting allowing interconnection of fittings.

FIG. 1d is a cross-sectional view of a preferred embodiment of the present invention comprising inflatable rails.

FIG. 2 is a side view of a preferred embodiment of the present invention using solid extruded material for the rails and further illustrates the dowel interconnect.

FIG. 2a is a cross-sectional view of a preferred embodiment of the present invention comprising rails made of solid extruded material.

FIG. 2b is a perspective view of two rail ends and a dowel interconnect.

FIG. 3 is an illustration of the present invention used in conjunction with a camera, tripod and dolly assembly.

FIG. 4 is an illustration of the present invention used in conjunction with a camera dolly. Also illustrated are the dolly push bar and the camera operator's seat.

### DETAILED DESCRIPTION OF THE INVENTION

Embodiments consistent with the present invention address the need for more portable, flexible, and smoother camera movement system and method in the film and video industry. The present invention may be implemented by using a variety of materials and methods. However, the description below is for the purpose of setting forth the preferred embodiment of the present invention.

In the film and video industry, cameras are mounted to dollies and run on tracks to ensure consistent movement and positioning. In a preferred embodiment of the present invention designed to accommodate heavier loads as shown in FIG. 1, a standard fitting (40) is positioned at one end of the flexible semi-rigid rail (15) to maintain air pressure in the chamber (20), while a custom fitting (41) having an inserted valve (30) is positioned and mounted at the other end of the flexible semi-rigid rail (15) to allow introduction and evacuation of gas. FIG. 1a illustrates a standard fitting (40) having ridges (42) which secure the standard fitting (40) to the flexible semi-rigid rails (15). FIG. 1b is a cross-sectional view of a customized fitting (41) having a valve (30) inserted into an opening made in the customized fitting (41). The customized fitting (41) also has ridges (42) to secure it to the flexible semi-rigid rails (15). FIG. 1c illustrates a connectable fitting (45) having a lip (46) which allows interconnection between fittings. The standard fitting (40), customized fitting (41) and the connectable fitting (45) can be used interchangeably.

As shown in FIG. 1d, the flexible semi-rigid rails (15) have reinforced linings (17) which form an inner compartment (20) and thereby may be filled with a gas, such as air. A valve (30) allows gas to be introduced to or evacuated from the inner compartment (20). The flexible semi-rigid rails (15) may be cut from standard material such as Pump Flex II hose made by Thermoid of Oneida, Tenn. Pump Flex II hose contains a one-eighth inch (⅛″) steel cage reinforced lining (17) and can be purchased in rolls of 500 feet thereby allowing practically limitless, seamless camera movement. For heavier loads, the inner compartment (20) of the flexible semi-rigid rails (15) may be inflated at thirty to sixty pounds (30-60 lbs.) per square inch to sufficiently support the weight of heavier dolly and camera equipment. To add further strength, the flexible semi-rigid rails (15) of a preferred embodiment have reinforced linings (17).

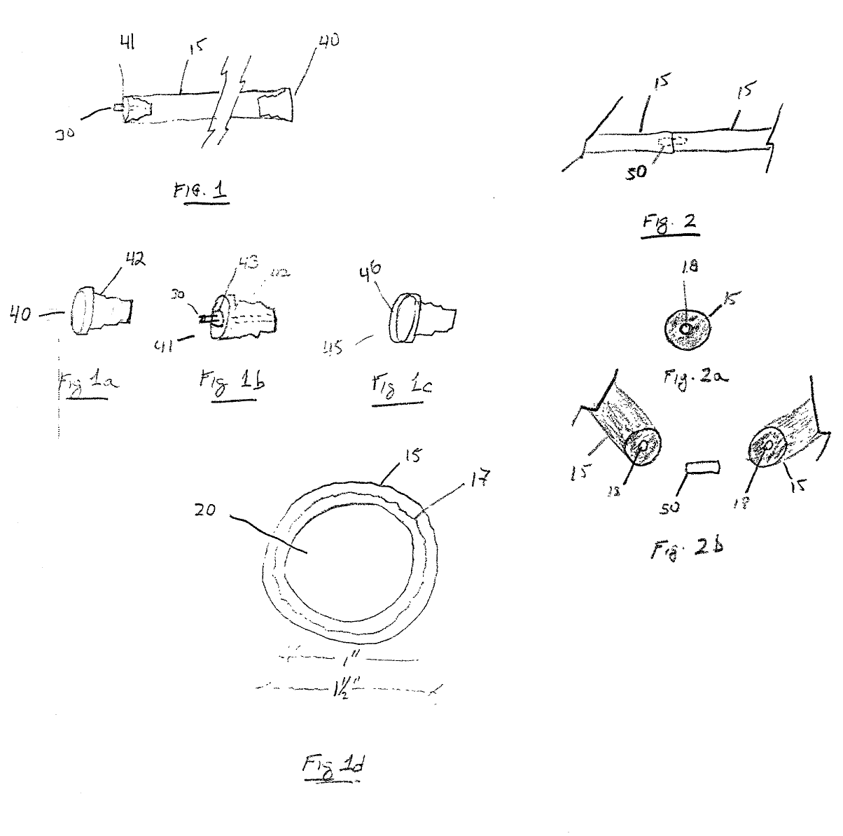

The present invention also may be used without inflation of the inner chamber (20) of the flexible semi-rigid rails (15) for lighter weight loads. FIG. 2 illustrates an alternative embodiment of the present invention. In this embodiment, solid extruded rubber, for example, Buna-Nitrile black rubber o-ring material made by Ameraflex of Dearpark, Tex., is used for the flexible semi-rigid rails (15). This solid, extruded material typically has a durometer rating of 90, a tensile strength of 1500 psi, and is commonly available in 1.5 inch diameter by 250 feet length. Also illustrated is the dowel connect method used to interconnect separate pieces of flexible semi-rigid rail (15). In this embodiment, a dowel (50) is partially inserted into each flexible semi-rigid rail (15) in order to accomplish interconnection. The dowel (50) may be of smooth or irregular shape and can be made of many kinds of material including wood and plastic.

FIG. 2a illustrates the solid cross-section of a flexible semi-rigid rail (15) of a preferred embodiment made from extruded rubber. A receptacle (18) is formed at the end of each of the flexible semi-rigid rails (15) to accept a dowel (50), thereby allowing interconnection. FIG. 2b is a perspective illustration showing two flexible semi-rigid rails (15), each with a receptacle (18) formed at each end. The partial insertion of a dowel (50) into each of the shown receptacles (18) allows for interconnection of the flexible semi-rigid rails (15).

As shown in FIG. 3, flexible semi-rigid rails (15) are positioned parallel to each other. Track wheels (100) are positioned at the bottom of the dolly (110), and a camera, often by virtue of a tripod, is mounted to the top of the dolly (11). The track wheels (100) are positioned to rest on the flexible semi-rigid rails (15) and the dolly (100) can run the length of the rails. Because the present invention may be bent in any curvature desired, the camera can be moved and positioned in practically any manner and around any corner when using the present invention. Accordingly, hard or impossible to reach places are now accessible with the present invention without need of preplanning. Further, because there are no seams in the present invention, smooth camera movement is ensured.

Another object of the present invention is to provide a moving and positioning apparatus and method that is lightweight and easy to transport. A standard forty-foot (40-ft.) pair of flexible tubes of the present invention weighs approximately eighty pounds (80 lbs.) and can be rolled in a bundle, eighteen inches (18″) in diameter by fourteen inches (14″) in height or it can also be rolled in slightly larger diameters with smaller heights, for example, twenty-five inches (25″) in diameter by eight inches (8″) in height.

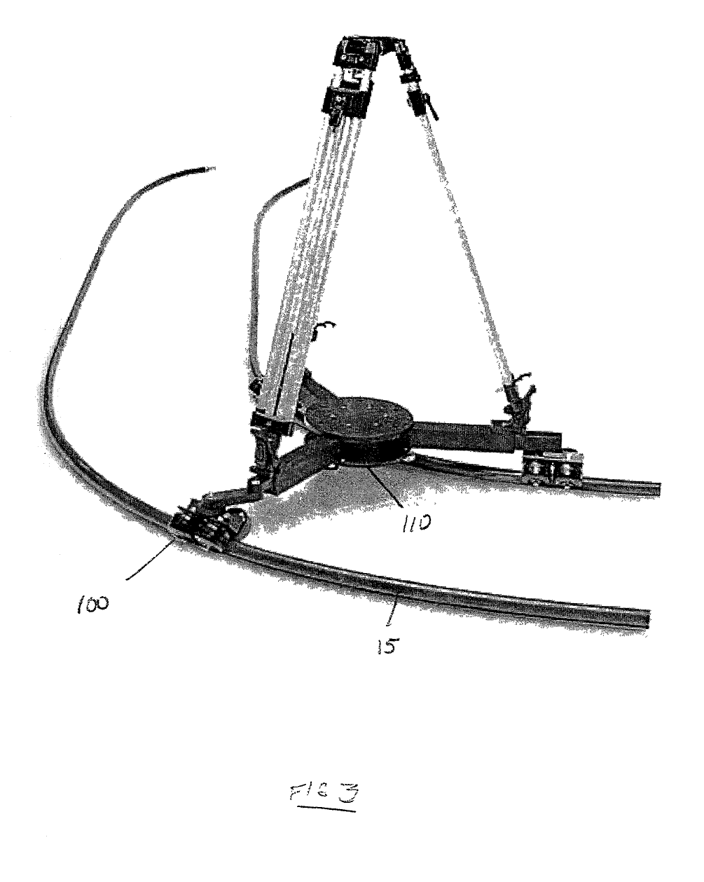

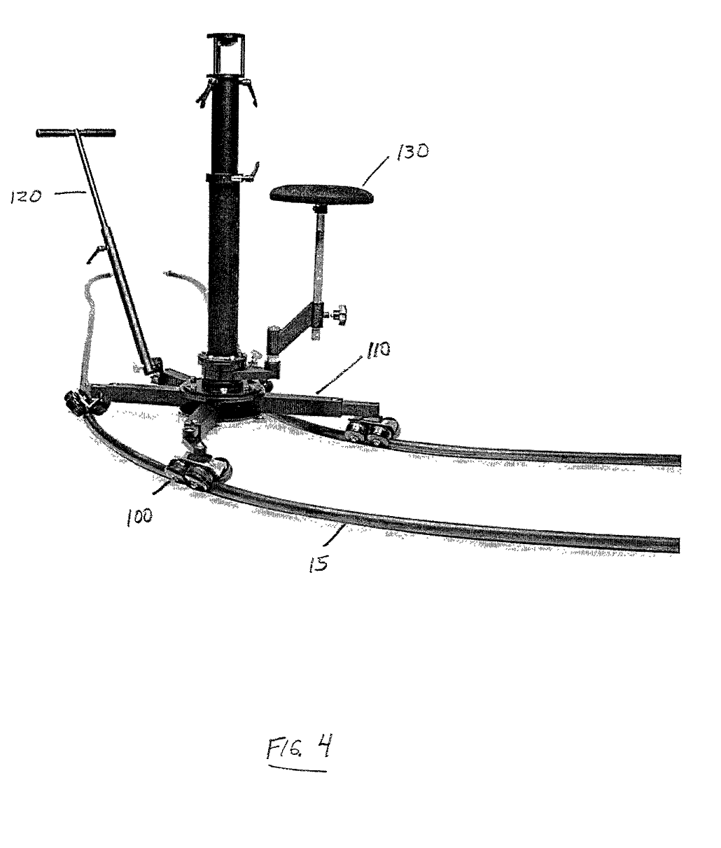

FIG. 4 illustrates the present invention positioned on a slightly different path as compared with that in FIG. 2. For the purposes of illustration, the dolly push bar (120) is shown. The push bar (120) is used by a dolly operator to push or pull the dolly, and therefore the camera, along the path of the flexible semi-rigid rails (15). A camera operator seat (130) is also shown.

Taken together, the present invention offers dramatic improvements to standard dolly track used in the film industry currently. Namely, the present invention provides a lightweight, portable, and completely flexible camera movement and positioning system and method.

We claim:

1. A moving and positioning apparatus, comprising:
a pair of flexible semi-rigid rails positioned parallel to each other whereby said pair of flexible semi-rigid rails support the weight and guide the positioning of a device.

2. The moving and positioning apparatus in claim 1, wherein each of said pair of flexible semi-rigid rails contain an inner chamber, said inner chamber having capacity to contain gas or liquid.

3. The moving and positioning apparatus in claim 2, further comprising a valve mounted to each of said pair of flexible semi-rigid rails whereby gas may be introduced to or evacuated from said chamber at said valve.

4. The moving and positioning apparatus in claim 1, wherein said pair of flexible semi-rigid rails have a durometer score of approximately 90.

5. The moving and positioning apparatus in claim 1, wherein each of said pair of flexible semi-rigid rails have reinforced linings.

6. The moving and positioning apparatus in claim 2 wherein each of said pairs of flexible semi-rigid rails have a pair of ends, where a valve and custom fitting assembly is mounted to one of said pair of ends, and a standard fitting is mounted to said other end of said pair of ends.

7. The moving and positioning apparatus in claim 2, wherein gas pressure in said chamber is maintained at about thirty to sixty pounds (30-60 lbs.) per square inch during use of said apparatus.

8. The moving and positioning apparatus in claim 6, wherein gas pressure in said chamber is maintained at about thirty to sixty pounds (30-60 lbs.) per square inch during use of said apparatus.

9. The moving and positioning apparatus in claim 1 or 2 wherein each of said pairs of flexible semi-rigid rails have a pair of ends, where a valve and custom fitting assembly is mounted to one of said pair of ends, and a connector fitting is mounted to said other end of said pair of ends whereby said connector fitting can be attached to a second connector fitting such that one of said flexible semi-rigid rails can be attached to a plurality of flexible semi-rigid rails.

10. The moving and positioning apparatus in claim 1 or 2, further comprising a second pair of flexible semi-rigid rails, said second pair of flexible semi-rigid rails being connected to said pair of flexible semi-rigid rails by a connection means.

11. The moving and positioning apparatus in claim 1 wherein said pair of flexible semi-rigid rails are of solid construction.

12. The moving and positioning apparatus in claim 4 wherein said pair of flexible semi-rigid rails are of solid construction.

13. The moving and positioning apparatus in claim 1 or 4 wherein said pair of flexible semi-rigid rails are made of solid, extruded rubber.

14. The moving and positioning apparatus in claim 10 wherein said connection means comprises a dowel, said dowel inserted into an opening located on each of said pair of flexible semi-rigid rails such that each of said pair of flexible semi-rigid rails can be connected to a second pair of flexible semi-rigid rails.

15. A moving and positioning method, comprising:
positioning a pair of flexible semi-rigid rails parallel to one another; and rolling the wheels of a dolly along the length of said pair of flexible semi-rigid rails.

16. The moving and positioning method in claim 15, further comprising inflating said pair of flexible semi-rigid rails with gas.

17. The moving and positioning method in claim 16, wherein said inflating said pair of flexible semi-rigid rails is done at a pressure of about thirty to sixty pounds (30 to 60 lbs.) per square inch.

18. The moving and positioning method in claim 15, wherein said pair of flexible semi-rigid rails form a chamber, said chamber having capacity to contain gas.

19. The moving and positioning method in claim 18, further comprising: a valve mounted to each of said pair of flexible semi-rigid rails whereby gas may be introduced or evacuated from said chamber by said valve.

20. The moving and positioning method in claim 15, wherein each of said pair flexible semi-rigid rails have reinforced linings.

21. The moving and positioning method in claim 15, further compromising connecting said pair of flexible semi-rigid rails to a second pair of flexible semi-rigid rails by a connection means.

22. The moving and positioning method in claim 17, wherein each of said pair flexible semi-rigid rails have reinforced linings.

23. The moving and positioning method in claim 15 wherein said flexible semi-rigid rails has a durometer score of approximately 90.

24. The moving and positioning apparatus in claim 15 wherein said pair of flexible semi-rigid rails are of solid construction.

25. The moving and positioning apparatus in claim 21 wherein said pair of flexible semi-rigid rails are of solid construction.

26. The moving and positioning apparatus in claim 23 wherein said pair of flexible semi-rigid rails are of solid construction.

27. The moving and positioning apparatus in claim 21 wherein said connection means comprises a dowel, said dowel inserted into an opening located on each of said pair of flexible semi-rigid rails such that each of said pair of flexible semi-rigid rails can be connected to a second pair of flexible semi-rigid rails.

28. The moving and positioning method, comprising:
positioning a pair of flexible semi-rigid rails parallel to one another; each of said pair of flexible semi-rigid rails forming a chamber;
inflating said chamber of each of said pair of flexible semi-rigid rails.

29. The moving and positioning method in claim 29, further comprising rolling a device along the length of said pair of flexible semi-rigid rails.

30. The moving and positioning method in claim 28, wherein said inflating said pair of flexible semi-rigid rails is done at pressure of about thirty to sixty pounds (30 to 60 lbs.) per square inch.

31. The moving and positioning method in claim 28, wherein each of said pair of flexible semi-rigid rails have reinforced linings.

32. The moving and positioning method in claim 28, further comprising:
a valve mounted to each of said pair of flexible semi-rigid rails whereby gas may be introduced or evacuated from said chamber by said valve.

33. The moving and positioning method in claim 30, wherein each of said pair flexible semi-rigid rails have reinforced linings.

34. The moving and positioning method in claim 32, wherein each of said pair flexible semi-rigid rails have reinforced linings.

35. The moving and positioning method in claim 28 or 29, further comprising:
connecting a second pair of flexible semi-rigid rails to said pair of flexible semi-rigid rails by a plurality of connector fittings.

36. The moving and positioning method in claim 28 or 29, further comprising:
connecting a second pair of flexible semi-rigid rails to said pair of flexible semi-rigid rails by an adhesive means.
